(19) United States
(12) Patent Application Publication
(10) Pub. No.: US 2025/0112291 A1
(43) Pub. Date: Apr. 3, 2025

(54) BATTERY MODULE

(71) Applicant: TOYOTA JIDOSHA KABUSHIKI KAISHA, Toyota-shi (JP)

(72) Inventors: Atsushi Yamanaka, Nagoya-shi (JP); Masato Ono, Nagoya-shi (JP); Shintaro Utsumi, Susono-shi (JP); Kazuhito Kato, Toyota-shi (JP); Yusuke Kintsu, Miyoshi-shi (JP); Takaaki Goto, Seto-shi (JP); Hiroki Awano, Susono-shi (JP)

(73) Assignee: TOYOTA JIDOSHA KABUSHIKI KAISHA, Toyota-shi (JP)

(21) Appl. No.: 18/761,718

(22) Filed: Jul. 2, 2024

(30) Foreign Application Priority Data
Oct. 2, 2023 (JP) 2023-171612

(51) Int. Cl. H01M 10/653; B60R 16/033; H01M 10/613; H01M 10/6555; H01M 10/6557; H01M 50/211

(52) U.S. Cl. CPC H01M 10/653; H01M 10/613; H01M 10/6555; H01M 10/6557; H01M 50/211; B60R 16/033; H01M 2220/20

(57) ABSTRACT

A battery module comprising: a plurality of battery cells; and a container containing the battery cells, wherein the container includes a housing containing the battery cells; and a plate-shaped member thermally connected to the housing and partitioning a space in which the battery cells of the housing are accommodated into a plurality of spaces, wherein the plate-shaped member includes a thermally conductive elastic body and a thermally conductive plate disposed on one or both sides of the thermally conductive elastic body.

### CROSS-REFERENCE TO RELATED APPLICATION

This application claims priority to Japanese Patent Application No. 2023-171612 filed on Oct. 2, 2023, incorporated herein by reference in its entirety.

### BACKGROUND

### 1. Technical Field

The present disclosure relates to a battery module.

### 2. Description of Related Art

A secondary battery that can be repeatedly used by charging may be used in a state in which a plurality of battery cells is accommodated in a container (hereinafter also referred to as a battery module).

Japanese Unexamined Patent Application Publication (Translation of PCT Application) No. 2020-524370 (JP 2020-524370 A) proposes a battery module with a function of suppressing flame propagation between battery cells.

### SUMMARY

In the battery module described in JP 2020-524370 A, the material of a member provided to suppress flame propagation is selected in consideration of heat insulation and heat resistance. For example, mica having an extremely low thermal conductivity is used in an embodiment according to JP 2020-524370 A. Therefore, the battery module described in JP 2020-524370 A may not have sufficient properties to dissipate heat from the cells during normal times.

An object of the present disclosure is to provide a battery module having an excellent function of suppressing flame propagation between battery cells and an excellent function of dissipating heat from the battery cells.

Means for addressing the above issue include the following aspects.

A battery module including:
a plurality of battery cells; and
a container that accommodates the battery cells, in which:
the container includes a housing that accommodates the battery cells, and a plate-shaped member that is thermally connected to the housing and partitions a space of the housing in which the battery cells are accommodated into a plurality of spaces; and the plate-shaped member includes a thermally conductive elastic body and a thermally conductive plate disposed on one side or both sides of the thermally conductive elastic body.
   2

The battery module according to 1, in which the plate-shaped member includes a thermally conductive elastic body and thermally conductive plates disposed on both sides of the thermally conductive elastic body.

3

The battery module according to 1 or 2, in which at least a part of a side wall that surrounds the space of the housing in which the battery cells are accommodated includes a thermally conductive elastic body.

4

The battery module according to any one of 1 to 3, in which the space of the housing in which the battery cells are accommodated is in a rectangular shape surrounded by two pairs of opposed side walls, and at least one pair of opposed side walls includes a thermally conductive elastic body.

5

The battery module according to any one of 1 to 4, in which the plate-shaped member has a flow path through which a refrigerant flows, the flow path being provided inside the plate-shaped member.

According to the present disclosure, it is possible to provide a battery module having an excellent function of suppressing flame propagation between battery cells and an excellent function of dissipating heat from the battery cells.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram schematically illustrating an example of a configuration of a battery module;

FIG. 2 is a diagram schematically illustrating an application of a battery module to a battery electric vehicle;

FIG. 3 is a diagram schematically illustrating an example of a configuration of a battery module;

FIG. 4 is a diagram schematically illustrating an exemplary configuration of a battery module; and

FIG. 5 is a diagram schematically illustrating an example of a configuration of a battery cell included in a battery module.

### DETAILED DESCRIPTION OF EMBODIMENTS

In the present disclosure, numerical ranges specified herein with “A-B,” “between A and B,” “(from) A to B,” etc., represent ranges, which include the minimum A and the maximum B.

In the numerical range described in the present disclosure in a stepwise manner, the upper limit value or the lower limit value described in a certain numerical range may be replaced with the upper limit value or the lower limit value of the numerical range described in another stepwise manner. In the numerical ranges described in the present disclosure, the upper limit value or the lower limit value described in a certain numerical range may be replaced with the value shown in the examples.

The battery module of the present disclosure includes:
a plurality of battery cells;

A container for accommodating the battery cell,
The container includes a housing for accommodating a battery cell, and a plate-shaped member thermally connected to the housing and partitions a space in which the battery cell of the housing is accommodated into a plurality of spaces,
The plate-shaped member includes a thermally conductive elastic body and a thermally conductive plate disposed on one or both sides of the thermally conductive elastic body.

The battery module of the present disclosure includes a plate-shaped member that partitions a space in which a battery cell of a housing is accommodated into a plurality of spaces.

Therefore, when an explosion or an ignition occurs in one of the battery cells, the propagation of the flame to the battery cells disposed in the space on the side where the battery cells are not disposed is prevented by the plate-shaped member.

Further, the plate-shaped member is thermally connected to the housing. Therefore, the heat generated in the battery cell is conducted to the housing via the plate-shaped member, and is dissipated to the outside of the battery module.

In the present disclosure, “the member A and the member B are thermally connected” means a state in which heat conduction is possible between the member A and the member B. Further, the plate-shaped member includes a thermally conductive elastic body and a thermally conductive plate disposed on one or both sides of the thermally conductive elastic body. When the plate-shaped member includes the thermally conductive elastic body, the plate-shaped member is in an elastically deformable state. Therefore, the battery cells in the container can always be brought into close contact with the plate-shaped member, and the heat generated in the battery cells is effectively dissipated through the plate-shaped member. In the present disclosure, the term “elastic body” means an object having a property of deforming upon application of a force and returning to its original shape upon removal of the force.

### Plate-Shaped Member

The plate-shaped member is thermally connected to a housing of a container that houses the battery cells, and partitions a space in which the battery cells of the housing are housed into a plurality of spaces.

From the viewpoint of efficiently dissipating the heat generated in the battery cell through the plate-shaped member, the plate-shaped member is preferably in a state of always being in close contact with the battery cell in the container.

The battery cell has a property of expanding during charging and contracting during discharging. Therefore, when the plate-shaped member does not include the thermally conductive elastic body, there is a possibility that a gap is formed between the plate-shaped member and the battery cell during discharge.

Since the plate-shaped member used in the present disclosure includes the thermally conductive elastic body, the plate-shaped member can be deformed following the volume variation of the battery cell, and can maintain a state in which the plate-shaped member is in close contact with the battery cell.

The state in which the plate-shaped member is in close contact with the battery cell can be created by, for example, placing the plate-shaped member in a state of being pressed by the battery cell. The condition in which the plate-shaped member is compressed by the battery cells can be created by, for example, designing the plate-shaped member to satisfy D1≤D2 relation. D1 is a dimension of a space for accommodating the battery cells partitioned by the plate-shaped member. D2 is a dimension when the volume of the battery cells accommodated in the space is minimized.

From the viewpoint of making the plate-shaped member elastically deformable, it is preferable that the heat conductive plate included in the plate-shaped member be deformable or displaceable in accordance with the deformation of the heat conductive elastic body.

Here, “deformable in response to deformation of the thermally conductive elastic body” means that the thermally conductive plate itself is deformable. The term “displaceable in response to deformation of the thermally conductive elastic body” means that the thermally conductive plate itself does not deform but can move in response to deformation of the thermally conductive elastic body (for example, move in the thickness direction of the plate-shaped member).

The plate-shaped member may have a laminated structure including a thermally conductive elastic body and thermally conductive plates disposed on both sides of the thermally conductive elastic body.

The material of the thermally conductive elastic body and the thermally conductive plate included in the plate-shaped member is not particularly limited as long as the material is excellent in thermal conductivity. From the viewpoint of achieving sufficient heat dissipation, the thermal conductivity of the material of the thermally conductive elastic body and the thermally conductive plate is preferably 10 W/(m·K) or more, more preferably 50 W/(m·K) or more, and even more preferably 100 W/(m·K) or more. Examples of the material having excellent thermal conductivity include metal, carbon, and silicon. Among them, metal is preferable from the viewpoint of strength and workability.

Specific examples of the metal include aluminum, copper, iron, nickel, gold, silver, platinum, cobalt, zinc, lead, tin, titanium, chromium, aluminum, magnesium, manganese, and an alloy containing the metal. Among these metals, copper, aluminum, and alloys thereof are preferable from the viewpoint of thermal conductivity and economic efficiency. From the viewpoint of weight reduction, aluminum and an aluminum alloy are preferable.

Specific examples of the thermally conductive elastic body included in the plate-shaped member include a metal sponge and an aggregate of metal fibers. Specific examples of the heat conductive plate included in the plate-shaped member include a metal plate.

From the viewpoint of heat dissipation efficiency, the ratio of the area of the main surface of the thermally conductive elastic body is preferably 50% or more, more preferably 70% or more, and still more preferably 90% or more of the area of the main surface of the plate-shaped member. The ratio of the heat conductive elastic body to the area of the main surface of the plate-shaped member may be 100%.

When the ratio is less than 100%, the thermally conductive elastic body may be provided in a pattern such as a stripe shape or a dot shape.

The plate-shaped member may have a flow path through which the refrigerant flows. When the thermally conductive elastic body has a porous structure, a void in the porous structure may be used as a flow path of the refrigerant. The refrigerant may be either a liquid or a gas.

### Housing

The housing constituting the container of the battery module is not particularly limited as long as it can accommodate a plurality of battery cells.

From the viewpoint of achieving sufficient heat dissipation, the thermal conductivity of the material of the housing is preferably 10 W/(m·K) or more, more preferably 50 W/(m·K) or more, and even more preferably 100 W/(m·K) or more. Examples of the material having excellent thermal conductivity include metal, carbon, and silicon. Among them, metal is preferable from the viewpoint of strength and workability.

Specific examples of the metal include aluminum, copper, iron, nickel, gold, silver, platinum, cobalt, zinc, lead, tin, titanium, chromium, aluminum, magnesium, manganese, and an alloy containing the metal. Among these metals, copper, aluminum, and alloys thereof are preferable from the viewpoint of thermal conductivity and economic efficiency. From the viewpoint of weight reduction, aluminum and an aluminum alloy are preferable.

The space in which the battery cells of the housing are accommodated is partitioned into a plurality of spaces by the plate-shaped member.

The plate-shaped member may or may not be removable from the housing.
The space in which the battery cells of the housing are accommodated may be partitioned by only the plate-shaped member described above, or may be partitioned by the plate-shaped member and a member (for example, an inner wall portion integrally molded with the housing) different from the plate-shaped member.

The housing may be in a state in which at least a part of the side wall surrounding the space for accommodating the battery cell includes the thermally conductive elastic body.

For example, in a case where the shape of the space for accommodating the battery cells of the housing is a rectangle surrounded by two pairs of opposed side walls, at least one pair of opposed side walls may include a thermally conductive elastic body.
Examples of the state in which the side wall includes the thermally conductive elastic body include a case in which the thermally conductive elastic body is included in the inside of the side wall, and a case in which the thermally conductive elastic body is disposed so as to be in contact with the inner wall surface of the side wall (the surface on the space side in which the battery is accommodated).
The side wall including the thermally conductive elastic body may include a thermally conductive plate together with the thermally conductive elastic body.

The number of battery cells respectively arranged in the space partitioned by the plate-shaped member (or the plate-shaped member and the other member) inside the housing may be one or a plurality.

Hereinafter, an example of a configuration of a container in which a battery cell is accommodated will be described with reference to the drawings. However, the embodiments of the present disclosure are not limited to the configurations described in the following drawings. In addition, the relative relationships between the sizes of the members and the sizes of the members shown in the drawings are conceptual, and the embodiments of the present disclosure are not limited thereto.

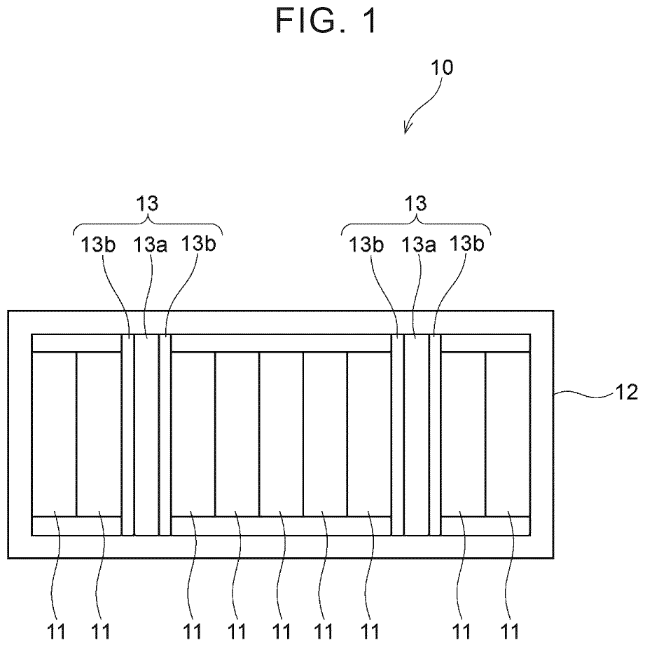

The battery module 10 illustrated in FIG. 1 includes a plurality of battery cells 11, a housing 12 of a container that houses the battery cells 11, and a plate-shaped member 13 that partitions a space in which the battery cells 11 of the housing 12 are housed into a plurality of spaces.

The plate-shaped member 13 includes a thermally conductive elastic body 13a and thermally conductive plate 13b disposed on both sides of the thermally conductive elastic body 13a.

When explosion or ignition occurs in one of the battery cells 11 in the battery module 10 shown in FIG. 1, propagation of flame to the battery cells 11 disposed in the space where the battery cell 11 is not disposed is prevented by the plate-shaped member 13.

Further, heat generated in the battery cell 11 is conducted from the plate-shaped member 13 to the housing 12, and is dissipated to the outside of the battery module 10. Since the plate-shaped member 13 includes the thermally conductive elastic body 13a and can be elastically deformed, it is kept in close contact with the neighboring battery cells 11 at all times.
A battery cell, comprising:

The battery cell included in the battery module of the present disclosure is not particularly limited as long as it can be accommodated in a container.

From the viewpoint of heat dissipation efficiency, it is preferable that the shape of the battery cell is a shape in which a contact area with the plate-shaped member is sufficiently secured. Examples of such a battery cell include a battery (a so-called laminate cell) in which the periphery of the electrode body is covered with a metal laminate film.

The type of the battery cell included in the battery module of the present disclosure is not particularly limited.

The battery cell can be selected from, for example, secondary batteries such as lithium-ion secondary batteries, lead-acid batteries, nickel-hydrogen batteries, nickel-cadmium batteries, nickel-iron batteries, nickel-zinc batteries, silver-zinc oxide batteries, and cobalt titanium lithium secondary batteries. The lithium ion secondary battery includes a liquid-based battery and an all-solid-state battery.
From the viewpoint of energy density, versatility, and the like, the battery cell may be a lithium ion secondary battery.

The lithium ion secondary battery includes, for example, a positive electrode, a negative electrode, a separator disposed between the positive electrode and the negative electrode as necessary, and an electrolyte.

The positive electrode includes, for example, a current collector and a positive electrode layer disposed on the current collector. The positive electrode layer includes a positive electrode material.

Examples of the positive electrode active material include a composite oxide of lithium and a transition metal (hereinafter, also referred to as a lithium transition metal composite oxide). Examples of the transition-metal include Ni, Co, Mn, Al, B, Mg, Ti, V, Cr, Fe, Cu, Zn, Ga, Sr, Zr, Nb, In, Sn, Ta, and W.
Examples of the lithium transition metal composite oxide include a layered lithium transition metal composite oxide, a spinel-type lithium transition metal composite oxide, and an olivine-type lithium transition metal composite oxide.
Examples of the layered lithium transition metal complex oxide include those containing at least one selected from Ni, Co, and Mn as the transition metal. Specifically, examples of the layered lithium transition metal complex oxide include compounds represented by the structural formulae of LiNiₐCO_{b}Mn_{c}O₂ (a, b, c are each a number of 0 or more and 1 or less, and a+b+c=1). Further, the layered lithium transition metal complex oxide may be a compound in which one or more elements selected from Al, Mg, La, Ti, Zn, B, W, Fe, Cr, V, Ru, Cu, Cd, Ag, Y, Sc, Ga, In, As, Sb, Pt, Au, Si, and the like are added to the compound. Specific examples of the spinel-type lithium transition metal complex oxide include LiMn₂O₄.
Specific examples of the olivine-type lithium transition metal complex oxide include LiMPO₄ (M: Fe, Co, Ni, or Mn).
The positive electrode active material contained in the positive electrode material may be one kind alone or two or more kinds thereof.
The positive electrode layer may contain components such as a conductive auxiliary agent and a binder in addition to the positive electrode active material.
Examples of the material constituting the current collector of the positive electrode include aluminum, an aluminum alloy, nickel, titanium, and stainless steel. Examples of the shape of the current collector include a foil and a mesh.

The negative electrode includes, for example, a current collector and a negative electrode layer disposed on the current collector and including a negative electrode active material.

Examples of the negative electrode active material include carbon materials such as graphite, hard carbon, soft carbon, and activated carbon, silicon, metallic lithium, lithium alloy, and lithium titanate (LTO).
The negative electrode layer may contain components such as a conductive auxiliary agent and a binder in addition to the negative electrode active material.
Examples of the material constituting the current collector of the negative electrode include copper, a copper alloy, nickel, titanium, and stainless steel. Examples of the shape of the current collector of the negative electrode include a foil and a mesh.

Examples of the separator include a nonwoven fabric, a cloth, and a microporous film containing a polyolefin as a main component, such as polyethylene and polypropylene. When the lithium ion secondary battery uses a solid electrolyte, the separator may not be used.

The electrolyte may be either a liquid or a solid. As the liquid electrolyte (electrolyte solution), a solution obtained by dissolving a lithium-salt such as LiPF₆ in an organic solvent can be used without any particular limitation. As the solid electrolyte, a known solid electrolyte such as a sulfide solid electrolyte, an oxide solid electrolyte, or a halide solid electrolyte can be used without any particular limitation. The solid electrolyte may be a polymer containing a lithium salt.

The battery module of the present disclosure may be mounted on a battery electric vehicle. A battery module according to an embodiment of the present disclosure is applied to a battery electric vehicle.

In the following description, “battery pack 10” means a structure including a plurality of battery modules.

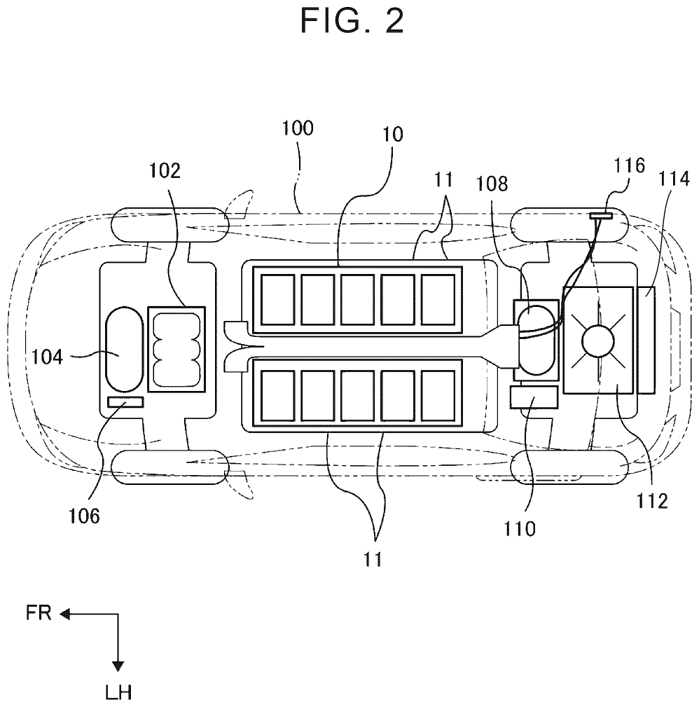

FIG. 2 is a schematic plan view showing a main part of a vehicle 100 to which the battery pack 10 according to the embodiment is applied. As illustrated in FIG. 2, the vehicle 100 is a battery electric vehicle (BEV: Battery Electric Vehicle) in which the battery pack 10 is mounted under the floor. Note that the arrows UP, the arrow FR, and the arrow LH in the drawings respectively indicate the upper side in the vehicle up-down direction, the front side in the vehicle front-rear direction, and the left side in the vehicle widthwise direction. In the case where the description is made using the front, rear, left, right, and up and down directions, the front and back directions in the vehicle front-rear direction, the left and right directions in the vehicle width direction, and the up and down directions in the vehicle vertical direction are shown unless otherwise specified.

In the vehicle 100 of the present embodiment, DC/DC converters 102, the electric compressor 104, and PTC (Positive Temperature Coefficient) heaters 106 are arranged in front of the vehicle relative to the battery pack 10. Further, a motor 108, a gear box 110, an inverter 112, and a charger 114 are disposed on the vehicle rear side of the battery pack 10.

The DC current outputted from the battery pack 10 is regulated by DC/DC converters 102 and then supplied to the electric compressor 104, PTC heaters 106, the inverter 112, and the like. Further, electric power is supplied to the motor 108 via the inverter 112, so that the rear wheels rotate to drive the vehicle 100.

A charging port 116 is provided on the right side portion of the rear portion of the vehicle 100, and electric power can be stored in the battery pack 10 via the in-vehicle charger 114 by connecting a charging plug of an external charging facility (not shown) from the charging port 116.

The arrangement, structure, and the like of the components constituting the vehicle 100 are not limited to the above-described configurations. For example, it may be applied to an engine-mounted hybrid electric vehicle (HV: Hybrid Vehicle) or plug-in hybrid electric vehicle (PHEV: Plug-in Hybrid Electric Vehicle). Further, in the present embodiment, the motor 108 is a rear-wheel-drive vehicle mounted on the vehicle rear portion, but the present disclosure is not limited thereto, and the motor 108 may be a front-wheel-drive vehicle mounted on the vehicle front portion, or a pair of motors 108 may be mounted on the vehicle front and rear. Further, the vehicle may be provided with an in-wheel motor for each wheel.

The battery pack 10 includes a plurality of battery modules 11. In the present embodiment, as an example, ten battery modules 11 are provided. Specifically, five battery modules 11 are arranged in the vehicle front-rear direction on the right side of the vehicle 100, and five battery modules 11 are arranged in the vehicle front-rear direction on the left side of the vehicle 100. The battery modules 11 are electrically connected to each other.

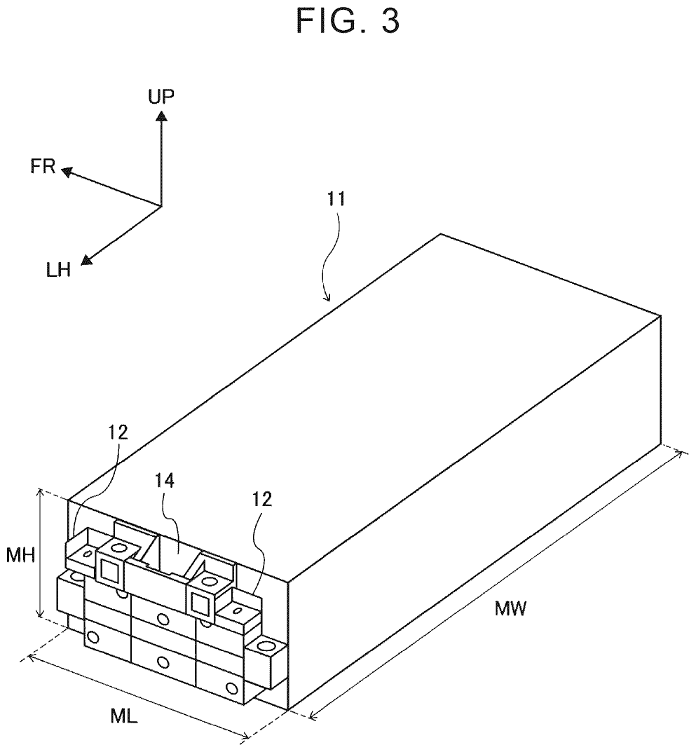

FIG. 3 is a schematic perspective view of the battery module 11. As shown in FIG. 3, the battery module 11 is formed in a substantially rectangular parallelepiped shape whose longitudinal direction is the vehicle width direction. The outer shell of the battery module 11 is made of an aluminum alloy. For example, an outer shell of the battery module 11 is formed by joining aluminum die-casting to both ends of an extruded material of an aluminum alloy by laser welding or the like.

A pair of voltage terminals 12 and a connector 14 are provided at both end portions of the battery module 11 in the vehicle width direction, respectively. A flexible printed circuit board 21, which will be described later, is connected to the connector 14. A bus bar (not shown) is welded to both end portions of the battery module 11 in the vehicle width direction.

The length MW of the battery module 11 in the vehicle width direction is, for example, 600 mm from 350 mm, the length ML in the vehicle front-rear direction is, for example, 250 mm from 150 mm, and the height MH in the vehicle vertical direction is, for example, 110 mm from 80 mm.

FIG. 4 is a plan view of the battery module 11 with the upper lid removed. As shown in FIG. 4, a plurality of battery cells 20 are accommodated in the battery module 11 in an arranged state. In the present embodiment, as an example, 24 battery cells 20 are arranged in the vehicle front-rear direction and adhered to each other.

A flexible printed circuit board (FPC: Flexible Printed Circuit) 21 is disposed on the battery cell 20. The flexible printed circuit board 21 is formed in a band shape with the vehicle width direction as a longitudinal direction, and thermistors 23 are provided at both end portions of the flexible printed circuit board 21. The thermistor 23 is not adhered to the battery cell 20 and is pressed toward the battery cell 20 by the upper lid of the battery module 11.

A space in which the battery cells 20 of the battery module 11 are accommodated is partitioned into a plurality of spaces by one or a plurality of plate-shaped members (not shown).

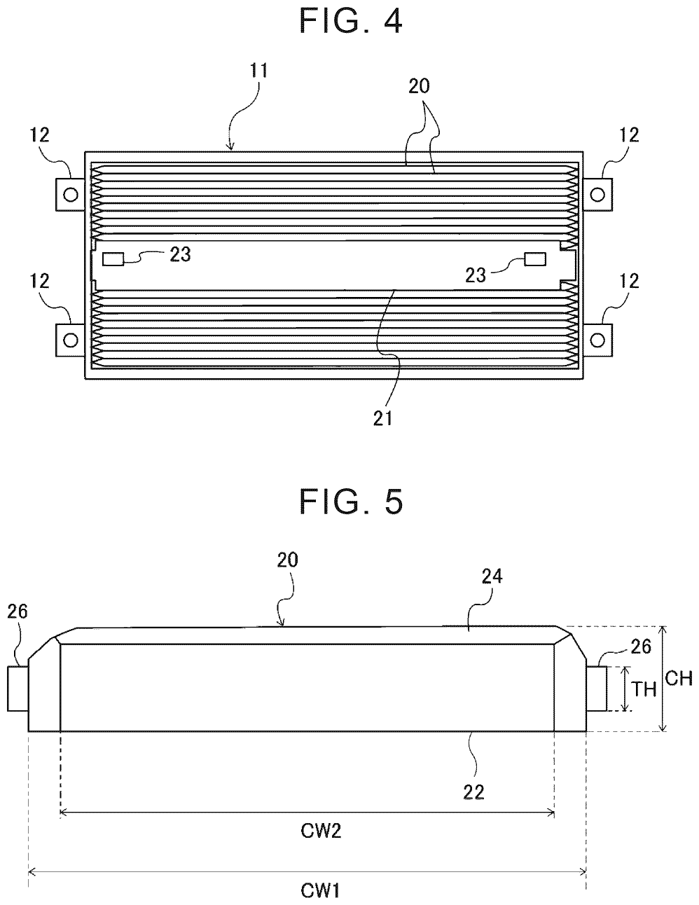

FIG. 5 is a schematic view of the battery cell 20 accommodated in the battery module 11 as viewed from the thickness direction. As shown in FIG. 5, the battery cell 20 is formed in a substantially rectangular plate shape, and an electrode body (not shown) is accommodated therein. The electrode body is formed by laminating a positive electrode, a negative electrode, and a separator, and is sealed with a laminate film 22.

In the present embodiment, as an example, the embossed sheet-like laminate film 22 is folded and bonded to form an accommodation portion of the electrode body. Although both of the single-cup embossing structure in which the embossing is performed at one place and the double-cup embossing structure in which the embossing is performed at two places can be adopted, in the present embodiment, the single-cup embossing structure has a 10 mm degree from the drawing depth 8 mm.

The upper ends of both end portions in the longitudinal direction of the battery cell 20 are bent, and the corners have an outer shape. Further, the upper end portion of the battery cell 20 is bent, and the fixing tape 24 is wound around the upper end portion of the battery cell 20 along the longitudinal direction.

Here, terminals (tabs) 26 are provided at both ends in the longitudinal direction of the battery cell 20. In the present embodiment, as an example, the terminal 26 is provided at a position offset downward from the center of the battery cell 20 in the vertical direction. The terminal 26 is joined to a bus bar (not shown) by laser welding or the like.

The vehicle-width-direction length CW1 of the battery cells 20 is, for example, 530 mm to 600 mm, 600 mm to 700 mm, 700 mm to 800 mm, and 800 to 900 mm, 1000 mm or more. The length CW2 of the area in which the electrode assembly is accommodated is, for example, from 500 mm to 520 mm, 600 mm to 700 mm, 700 mm to 800 mm, and from 800 to 900 mm, 1000 mm or more. The height CH of the battery cell 20 is, for example, from 80 mm to 110 mm, 110 mm to 140 mm. In addition, the thickness of the battery cell 20 is from 5.0 mm to 7.0 mm, 7.0 mm to 9.0 mm, 9.0 mm to 11.0 mm, and the height TH of the terminal 26 is from 40 mm to 50 mm, 50 mm to 60 mm, 60 mm to 70 mm.

What is claimed is:

1. A battery module comprising:
a plurality of battery cells; and
a container that accommodates the battery cells, wherein:
the container includes a housing that accommodates the battery cells, and a plate-shaped member that is thermally connected to the housing and partitions a space of the housing in which the battery cells are accommodated into a plurality of spaces; and
the plate-shaped member includes a thermally conductive elastic body and a thermally conductive plate disposed on one side or both sides of the thermally conductive elastic body.

2. The battery module according to claim 1, wherein the plate-shaped member includes a thermally conductive elastic body and thermally conductive plates disposed on both sides of the thermally conductive elastic body.

3. The battery module according to claim 1, wherein at least a part of a side wall that surrounds the space of the housing in which the battery cells are accommodated includes a thermally conductive elastic body.

4. The battery module according to claim 1, wherein the space of the housing in which the battery cells are accommodated is in a rectangular shape surrounded by two pairs of opposed side walls, and at least one pair of opposed side walls includes a thermally conductive elastic body.

5. The battery module according to claim 1, wherein the plate-shaped member has a flow path through which a refrigerant flows, the flow path being provided inside the plate-shaped member.
